(19) United States
(12) Patent Application Publication
(10) Pub. No.: US 2026/0253872 A1
(43) Pub. Date: Aug. 27, 2026

(54) METHOD FOR PRODUCING AN SI ANODE SOLID-STATE ELECTROLYTE COMPOUND AND A SOLID-STATE LI ION BATTERY CELL AND SOLID-STATE LI ION BATTERY

(71) Applicant: NORCSI GMBH, Halle (DE)

(72) Inventors: Udo REICHMANN, Wilsdruff (DE); Andreas KRAUSE-BADER, Dresden (DE); Marcel NEUBERT, Kreischa (DE)

(73) Assignee: NORCSI GMBH, Halle (DE)

(21) Appl. No.: 18/875,991

(22) PCT Filed: Feb. 8, 2023
(86) PCT No.: PCT/EP2023/053069

§ 371 Date: Dec. 17, 2024

(30) Foreign Application Priority Data
Jun. 20, 2022 (DE) 10 2022 115 233.2

(51) Int. Cl. H01M 4/1395; H01M 4/02; H01M 4/04; H01M 4/134; H01M 4/38; H01M 4/66; H01M 10/0525; H01M 10/0562; H01M 10/0585

(52) U.S. Cl. CPC H01M 4/1395; H01M 4/0407; H01M 4/0423; H01M 4/0471; H01M 4/134; H01M 4/386; H01M 4/661; H01M 10/0525; H01M 10/0562; H01M 10/0585; H01M 2004/027; H01M 2300/0071

(57) ABSTRACT

The invention relates to a method for producing a flat silicon anode solid-state electrolyte compound, which is suitable for use in a solid-state battery, and a flat silicon anode solid-state electrolyte compound produced in this way. The object of the invention is to provide a method with which a silicon anode solid-state electrolyte compound can be produced, which guarantees a consistent, good electrical contact between the cell layers, wherein said object is achieved with a method for producing a flat silicon anode solid-state electrolyte compound which is suitable for use in a solid-state battery, wherein a multi-layer structure as an active layer of the Si anode is deposited onto a porous solid-state electrolyte in a dry deposition method, wherein the multi-layer structure undergoes a rapid tempering, and a current collector, preferably made of copper, is deposited onto the multi-layer structure.

The invention relates to a method for producing a planar silicon anode-solid electrolyte connection suitable for use in a solid-state battery, and to a planar silicon anode-solid electrolyte connection thus produced.

The invention also relates to a solid-state battery cell comprising a cathode and the planar silicon anode-solid electrolyte connection of the invention, and to a solid-state battery comprising at least one solid-state battery cell.

As an introduction, certain principles relating to batteries as electrochemical energy stores, along with related terms that are used, are restated and defined.

Batteries are electrochemical energy stores and are differentiated as primary and secondary batteries.

Primary batteries are electrochemical power sources in which chemical energy is converted irreversibly into electrical energy. A primary battery is therefore not rechargeable. Secondary batteries, also called accumulators, on the other hand, are rechargeable electrochemical energy stores in which the chemical reaction that takes place is reversible, enabling multiple use. During charging, electrical energy is converted into chemical energy, and on discharge it is converted back from chemical to electrical energy.

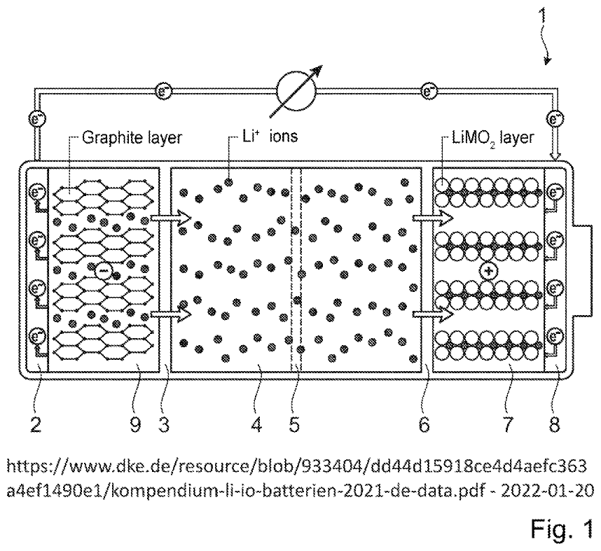

“Battery” is the headline term for interconnected cells. Cells are galvanic units which consist of two electrodes, electrolyte, separator, and cell casing. FIG. 1 shows an illustrative construction and the function of a lithium-ion cell during discharging. Each Li-ion cell consists of two different electrodes 7, 9: an electrode 9, which is negatively charged in the charged state, and an electrode 7, which is positively charged in the charged state. Since release of energy, in other words discharge, is accompanied by migration of ions from the negatively charged electrode to the positively charged electrode, the positively charged electrode is called the cathode 7 and the negatively charged electrode is called the anode 9. The electrodes are each composed of a current collector 2, 8 and of an active material applied thereon. Located between the electrodes are firstly the ion-conducting electrolyte 4, which enables the required exchange of charge, and the separator 5, which ensures electrical separation of the electrodes.

Solid-state accumulators or batteries differ from the conventional accumulators in particular in the solid electrolyte. The object of the electrolyte is the conduction of ions between anode and cathode.

Battery cells can be connected in different ways. If two battery cells are connected in series, the anode (negative electrode) of one battery cell is connected to the cathode (positive electrode) of the other (considered on discharging). With serial connection of battery cells, there is an increase in the overall voltage: The voltages of the individual cells are added together. If battery cells are connected in parallel, all of the cathodes (positive electrodes) are connected to one another, as are all of the anodes (negative electrodes)-considered during discharge. In the parallel connection of cells, the capacitance (Ah) of the battery is doubled. The same applies to the parallel connection of batteries to form battery modules.

In presently available lithium-ion batteries, a liquid electrolyte is used in order to utilize lithium between the electrodes (anode and cathode) for the storage and release of energy. Given the low potential window for stable operation with water-based electrolytes, organic solvents are used. These solvents harbor a high flame potential and increase the fire risk of the batteries. The use of solid electrolytes, which possess much lower flammability, is seen as a solution. The solid electrolyte, with the properties of good ionic conductivity combined with good electrical insulation, is able to replace the existing liquid electrolyte and separator. At the same time, when using solid electrolytes, the volume and weight are reduced through an increased energy density, especially when using metallic lithium, and the packing density can be significantly increased as a result.

The disadvantage of the solid electrolytes, however, is the low flexibility and also the difficulty in contacting anode and cathode for effective ion conductivity. Surface contacting of the anode in relation to the solid electrolyte is critical to good battery performance. Particularly with pulverulent starting materials of ceramic electrolytes, composed of sintered powders, for example, with high surface porosity, the limited ionic contact at the boundary layer between cathode-electrolyte or electrolyte-anode may massively reduce the power of the battery. In the case of high surface currents, moreover, lithium metal with solid ceramic electrolytes forms dendrites, which can destroy the battery. In addition, lithium reacts with the solid electrolyte at the surface, with a consequent drop in ionic conductivity in operation. Of the various known possibilities for improving electrical contact, examples are the addition of liquid electrolyte, the softening/mixing of the solid electrolytes using polymers and/or binders, or the use of relatively soft, sulfur-based solid electrolytes, such as the lithium argyrodites. Argyrodites are lithium-rich solid-state compounds. The argyrodite family consists of more than 100 crystalline solids and extends, for example, to solid-state compounds in which the silver is replaced by copper, the germanium by gallium or phosphorus, and the sulfur by selenium. Alternatively, high pressing pressures are also used, which are necessary in particular with volume expansion during battery operation, in order to ensure consistent contact. For a commercial construction, however, the high pressure required for this purpose is associated with high cost and complexity.

For effective ion conductivity within the solid electrolytes, therefore, a high degree of crystallinity is typically needed, with corresponding defects in the crystal lattice. In the case of oxidic materials, such as lithium lanthanum zirconium oxide (LLZO) garnet crystals, this requires a very high crystallization temperature, which is well above the temperatures that must be observed for the integrity of the other battery components, especially the anode. When constructing a solid electrolyte-anode connection, therefore, it has hitherto been vital for the process steps involving the highest required temperature to take place first, with the temperature being then reduced as required. In relation to the construction of the solid electrolyte-anode connection, therefore, it is necessary first to produce a solid ceramic electrolyte, then to construct the anode, and finally to deposit the copper current collector. For graphite-based anodes, it is known practice from the prior art to deposit this battery graphite on the anode side of a separator; however, this has been employed primarily to check/prevent shuttle transport of sulfur in lithium-sulfur batteries.

It is therefore an object of the present invention to specify a method by means of which a silicon anode-solid electrolyte connection can be produced, with the silicon anode-solid electrolyte connection not having the disadvantages identified above.

It is also an object of the invention to specify a solid-state battery cell or solid-state battery that does not have the disadvantages identified above.

The object is achieved by a method according to independent method claim 1.

In the method for producing a planar silicon anode-solid electrolyte connection suitable for use in a solid-state battery, a multistratum structure is deposited as active layer of the Si anode onto a porous solid electrolyte in a dry deposition method, with the multistratum structure being subjected to accelerated annealing and with a current collector composed preferably of copper being deposited on the multistratum structure.

A porous solid electrolyte is understood to be a layer of a sintered powder. The powder is formed from ceramics, which are pressed to form a layer and heated.

A multistratum structure is understood to be a stratified structure consisting of two or more strata, although the term “multistratum structure”, within the disclosure content of this invention, likewise embraces a single stratum.

The method of the invention is particularly suitable for producing battery cells for a wide variety of different battery applications, as it enables a complete and planar solid electrolyte-silicon anode construction in particulate form with adjuvants for stabilizing the multilayer construction of the active layer of the anode. Through the use of dry production methods, such as sputtering or electron-beam vaporization, for example, it is possible, planarly, not only to deposit a multistratum structure onto the solid electrolyte directly as an active layer of the anode but also, without extra cost and complexity, to apply an additional interlayer for stabilization of the solid-state electrolyte/anode interface. The accelerated annealing enables targeted control of the energy input into the layers.

In one configuration of the method of the invention, an interlayer for stabilization between the solid electrolyte and the active layer of the Si anode is deposited between the solid electrolyte and the multistratum structure.

It is particularly advantageous that the silicon anode-solid electrolyte connection is produced in reverse order relative to existing methods. As a result, it becomes possible to apply the anode directly on the solid electrolyte, and so an optimal ionic contact to the solid electrolyte, which is normally difficult to contact, is realizable.

If the production method is commenced with the solid electrolyte, the current collector can be optimized on the anode side such that it need no longer fulfill any necessarily load-bearing function. Consequently, the thickness of material of the copper current collector can be reduced to the current density actually needed in the application, and hence weight and layer thickness can be reduced, without any adverse effect on the thermal delivery of heat. All in all, a significant weight reduction and hence increase in the gravimetric energy density can be achieved.

The planar deposition process in a dry deposition method means that the production method of the invention guarantees consistent layer construction. The fundamental process steps give rise to a massive spectrum of parameters which can be optimized in a targeted way to the corresponding application. In particular, the accelerated annealing forms a critical advantage through the targeted energy input. With the accelerated annealing, the energy input can be controlled stratum by stratum, so as to realize a functioning Si anode through to an all-solid-state battery (ASSB).

In a further configuration of the method of the invention, therefore, the multistratum structure is deposited stratum by stratum, with the multistratum structure being formed from at least one layer of a metal and/or silicon or from a mixed system which consists of silicon admixed with at least one metal.

The multistratum structure is formed from at least one stratum. A stratum refers to a deposited layer of active material of the anode; depending on the stratum thickness, the active layer of the electrode/anode may be constructed of one or more strata. The at least one stratum may on the one hand be formed of at least one metal and/or silicon. In that case, the silicon and the at least one metal are applied alternately by separate layer deposition of the materials. A stratum is therefore formed from at least one layer of at least one metal and a layer of silicon; for attaining the target thickness of the anode, multiple strata are embodied in the multistratum structure. Alternatively, the at least one stratum may also be formed by a mixed system, with the mixed system consisting of silicon admixed with at least one metal. This mixture of at least one metal and silicon, usually in powder form, is deposited until the active layer reaches its target thickness.

Intercalation of lithium is accompanied by volume expansion, but there is no pulverization of the silicon layer of the Si anode, owing to the admixing of metals and the use of the multistratum structure. The admixing of metals leads to formation of alloy, with reduced hardness as compared with pure silicon. At the same time, a very high electrical conductivity of the silicon, in comparison to graphite, is generated. Despite the admixing of metals, a specific overall capacity of more than 2000 mAh/g is ensured.

The stability and high electrical conductivity of the silicon anode are supported by the development of a heterogeneous construction, with formation of a conductive matrix of metals or metal silicides which envelop the amorphous regions of the silicon.

In one configuration of the production method of the invention, the metal is formed from at least one of the materials manganese (Mn), cobalt (Co), iron (Fe), titanium (Ti), nickel (Ni), aluminum (Al), tin (Sn), gold (Au) and/or silver (Ag) or a mixture of these materials.

In a different configuration of the production method of the invention, the dry deposition method is a PVD process: sputtering, for example. Preferred methods are sputtering and electron-beam vaporization. Likewise possible are CVD (chemical vapor deposition) methods such as plasma-enhanced CVD (PECVD), or PVD (physical vapor deposition) methods such as thermal vaporization or the PLD (pulsed laser deposition) method.

In a further different configuration of the production method of the invention, the accelerated annealing controls energy input into the deposited strata of the multistratum structure and/or layers of the Si anode-solid electrolyte connection or else solid-state battery cell and/or solid-state battery.

Through the use of the accelerated annealing, the planar construction of the Si anode-solid electrolyte connection of the invention can take place firstly in the order represented above, i.e., solid electrolyte-active layer-current collector, and secondly in reverse order, beginning with the current collector, followed by the active layer of the anode and the construction of a solid electrolyte with further processes and/or PVD methods. Since contact of the solid electrolyte-anode interface in particular is critical to battery performance, just a thin layer is sufficient to produce stable contact. The required crystallinity or ion conductivity in the solid electrolyte can be produced by means of the accelerated annealing.

In other words, in a different configuration of the method of the invention, the method steps for producing the planar silicon anode-solid electrolyte connection take place in reverse order, specifically such that the multistratum structure is deposited as active layer on the current collector of the Si anode, preferably copper, in a dry deposition method, and is subsequently subjected to accelerated annealing with a controlled and adjustable energy input into the multistratum structure of the Si anode; an interlayer is deposited on the multistratum structure for stabilization between the solid electrolyte and the active layer of the Si anode; and the solid electrolyte is deposited, the latter being subjected to accelerated annealing for crystallization of the solid electrolyte.

In one configuration of the production method of the invention, the accelerated annealing is a flash-lamp annealing and can be carried out by means of a flash lamp having a flash light duration in the range from 0.2 to 20 ms and an energy density in the range from 0.3 to 160 J/cm² and also with preheating or cooling in the range from 4° C. to 200° C.

In a different configuration of the production method of the invention, the accelerated annealing is a laser annealing and can be carried out by means of a laser with an annealing time in the range from 0.01 ms to 100 ms by the establishment of a rate of scanning of a local heating site and an energy density in the range from 0.1 to 100 J/cm² and also with preheating or cooling in the range from 4° C. to 200° C.

The stated temperature range from 4° C. to 200° C. relates to the surface temperature of the substrate or of the layer to be annealed.

It has emerged that the effect of the accelerated annealing differs for the deposition of different materials in the active layer. The cause of this is considered to be the wide variety of different chemical events in connection with silicon. As a result, different structures can be formed in the anode layer generated—for example, column structures in the case of nickel. Furthermore, different silicides may be formed, which intercalate lithium as well—in contrast to Cu silicides, whose capacity to intercalate lithium is negligible or zero. An advantage of exploiting the stated differences is that it can be used to control the volume expansion of silicon on intercalation of lithium. As a result, the stability of battery operation is significantly enhanced.

In the case of titanium, Ti silicide is formed, which in the correct phase may have Li intercalation capacity (see: Xu, J. et al. Preparation of TiSi₂ Powders with Enhanced Lithium-Ion Storage via Chemical Oven Self-Propagating High-Temperature Synthesis. Nanomaterials 11, 2279 (2021)). This has the advantage that there is no clear interface between Li-active and Li-inactive and consequently there is good electrical contact even during cycling. Further metals such as aluminum, for example, do not form any compound with silicon-that is, do not form any silicides. As a consequence of this, these metals mix in silicon and the electrical conductivity is increased. In the accelerated annealing step, there may additionally be improvements in the morphology and hardness of the silicon-metal layer relative to the hard pure silicon.

The reactions compelled by the accelerated annealing between the silicon particles and the metal particles in the active layer of the Si anode are non-equilibrium processes, which are realizable only in the ms range and therefore necessitate the use of a flash lamp or a laser.

The heating ramps achieved in the accelerated annealing are situated in the range necessary in the method, of 10⁴-10⁷ K/s. For this, the flash-lamp annealing utilizes a spectrum in the visible wavelength range, whereas the laser annealing uses discrete wavelengths in the range of the infrared (IR) to ultraviolet (UV) spectrum.

On the arrangement side, the object is achieved by a planar silicon anode-solid electrolyte connection according to independent arrangement claim 10.

In the case of the planar silicon anode-solid electrolyte connection of the invention produced with the method according to the aforesaid method claims 1 to 9, the solid electrolyte consists preferentially of an oxidic material, more particularly of garnet-structure oxides, NASICON-type phosphate glass-ceramics or oxynitrides.

Garnet-structure oxides belong structurally to the nesosilicates, such as, for example, the widely investigated lithium lanthanum zirconium oxide (LLZO). NASICON-type phosphate glass-ceramics receive their name from the chemical structure of the NaZr₂(PO₄)₃ and possess high ionic conductivity for lithium ions. Examples include LAGP (lithium aluminum germanium phosphate) and LATP (lithium aluminum titanium phosphate). Oxynitrides are oxides which generate numerous defects in the lattice, owing to the replacement of some oxygen atoms by nitrogen, so producing a high ionic conductivity; for example, xLi₂O:yP₂O₅:zPON, abbreviated to LiPON. LiPON can be produced by the sputtering of Li₃PO₄ in a reactive N₂ plasma.

The Si anode-solid electrolyte connection of the invention comprises a solid electrolyte which is realized from oxidic materials, in particular from garnet-structure oxides, such as LLZO, NASICON-type phosphate glass-ceramics, such as LATP or LAGP, and oxynitrides, such as LiPON, for example. The oxidic materials require a high degree of crystallinity for effective ionic conductivity, so necessitating a high process temperature. The process temperatures are situated in the region of room temperature for LiPON sputtered layers, up to 1230° C. for sufficiently crystalline sintered LLZO ceramics, and about 700° C. for the glass transition temperature of NASICON ceramics.

The stated oxidic materials are particularly suitable for use in an ASSB since they possess an ionic conductivity of more than 1 mS/cm (millisiemens per centimeter) and are very stable both thermally and chemically.

In a different configuration of the Si anode-solid electrolyte connection of the invention, the solid electrolyte has a crystallinity with high ion conductivity that can be adjusted in a targeted way by means of the accelerated annealing.

The accelerated annealing enables the construction, as stated above, of the planar Si anode-solid electrolyte connection of the invention. The surface contact enables the effective ionic conductivity between the active layer of the Si anode and the solid electrolyte. The artificial SEI, as an interlayer between the Si anode and the solid electrolyte, is able additionally to improve the contact between the two layers. The alternative would be poor contact between Si anode and solid electrolyte, manifested in degradation of the surface of the solid electrolyte, particularly in the case of Li metal anodes.

The object of the invention is also achieved by a solid-state battery cell comprising a cathode and a planar silicon anode-solid electrolyte connection produced with the method according to claims 1 to 9, with the Si anode, the solid electrolyte and the cathode being embodied with a planar construction.

The production of a complete solid-state battery cell or solid-state battery in a planar deposition method together with the solid electrolyte is particularly advantageous, because the planar construction enables the production of a solid electrolyte on a planar Si anode and also enables the application of an Si anode and a copper current conductor directly on the solid electrolyte.

In a further different configuration of the solid-state battery cell of the invention, an active layer as cathode is formed of LiFePO₄, LiMnO₂ or LiCoO₂ and a current collector, preferably composed of aluminum, is formed on the active layer as cathode.

Materials especially suitable for the cathode are those which enable dry deposition. A known procedure from the prior art is the stratum-by-stratum deposition of LiFePO₄ as cathode. The specified materials can be produced in planar form by sputtering (see: 1. Bünting, A., Uhlenbruck, S., Sebold, D., Buchkremer, H. P. & Vaßen, R. Three-Dimensional, Fibrous Lithium Iron Phosphate Structures Deposited by Magnetron Sputtering. ACS Appl. Mater. Interfaces 7, 22594-22600 (2015) or 2. Fischer, J. et al. Development of thin film cathodes for lithium-ion batteries in the material system Li—Mn—O by r.f. magnetron sputtering. Thin Solid Films 528, 217-223 (2013), which is especially suitable for the production of layer stacks.

In one configuration of the solid-state battery cell of the invention, an anode-side construction comprising the Si anode-solid electrolyte connection and an Si anode-copper current collector connection and also a cathode-side construction comprising a solid electrolyte-cathode-aluminum current collector connection and/or catholyte-aluminum current collector connection can be produced and constructed separately from one another, with the Si anode-solid electrolyte connection and the Si anode-copper current collector connection and also the solid electrolyte-cathode-aluminum current collector connection and/or the catholyte-aluminum current collector connection being configured in a manner connectable to one another in a final fabrication step by way of a respective bulk contact.

As a result of the method of the invention, it is possible for the first time to realize the production order of the layers of a complete solid-state battery cell in different orders of production, and to produce all parts of the solid-state battery cell even separately from one another, with the feature that the transition contacts are already fully formed. A transition contact refers, for example, to the interface between Si anode and solid electrolyte. All that remains, therefore, is to assemble materials which are equally formed. In the case of the anode-side construction, it is possible for the first time, by virtue of the planar construction, to apply the active layer of the Si anode directly to a solid electrolyte and then to deposit the copper current collector, or else first to deposit the planar active layer on the Cu current collector, and then the solid electrolyte. For the cathode-side construction, there are already methods in existence for coupling the solid electrolyte and the cathode to one another, i.e., for applying the active layer of the cathode to a solid electrolyte, and then the Al current collector, or for depositing the active layer of the cathode on the Al current collector, and then the solid electrolyte. The layer compositions, i.e., Si anode-solid electrolyte and/or Cu current collector-Si anode and/or solid electrolyte-cathode-aluminum current collector, can now be produced separately from one another in order to simplify manufacture; for the manufacture or formation of the solid-state battery cell, these layer compositions are connected to/brought into conjunction with one another by way of their respective bulk contacts. A bulk contact refers, for example, in the context of the connection between the Si anode-solid electrolyte and Cu current collector-Si anode layer compositions, to the coupling of the active layer parts, or, in the context of the connection between the Si anode-solid electrolyte and solid electrolyte-cathode-aluminum current collector layer compositions, to the coupling by way of the solid electrolyte. The coupling may optionally be supported by a temperature step.

The object of the invention is also achieved by a solid-state battery consisting of more than one solid-state battery cell, with the more than one solid-state battery cell being planarly applied and stacked atop one another with the production methods provided. The contacting may be embodied in a manner connected to one another in parallel and/or in series.

The invention is to be elucidated in more detail below with reference to exemplary embodiments.

The content of the drawings is as follows:

FIG. 1 Illustrative construction and function of a lithium-ion cell with liquid electrolyte during discharging (prior art);

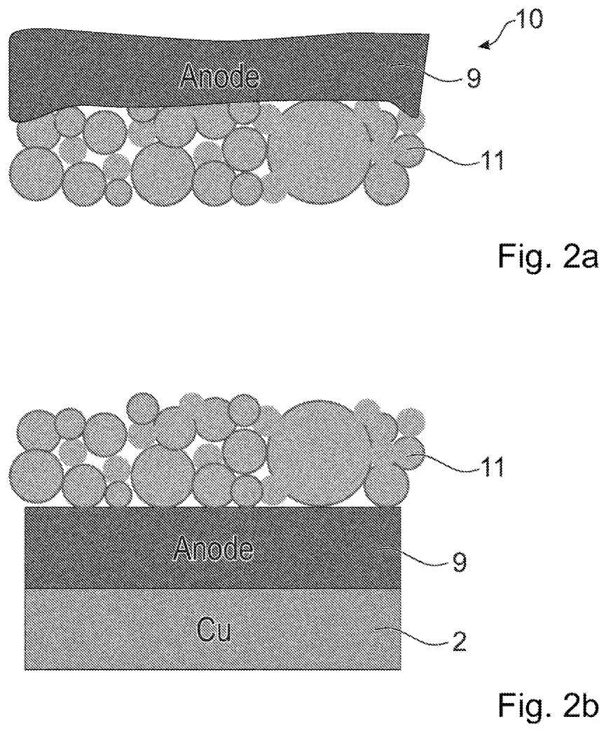

FIG. 2 Sequence of the production method of the invention for an Si anode-solid electrolyte connection a) in the following order: solid electrolyte-anode; b) in the following order: current collector-active layer-solid electrolyte;

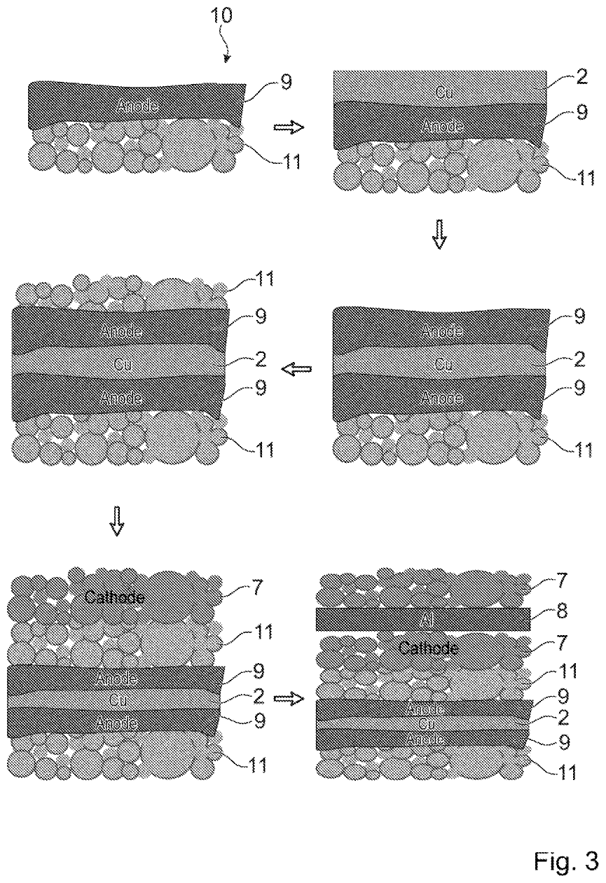

FIG. 3 Construction of a solid-state battery cell and further layers produced according to the method of the invention by battery cell components stacked atop one another;

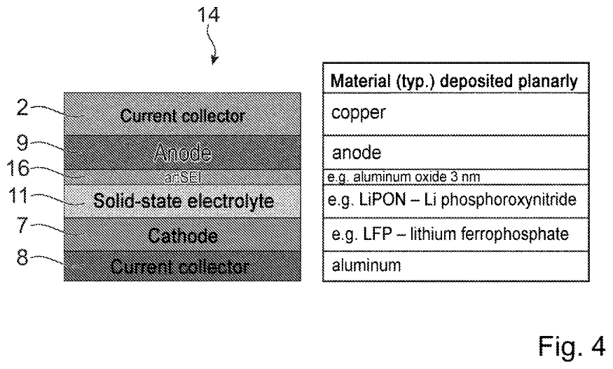

FIG. 4 Schematic representation of a solid-state battery cell with example materials for the individual layers;

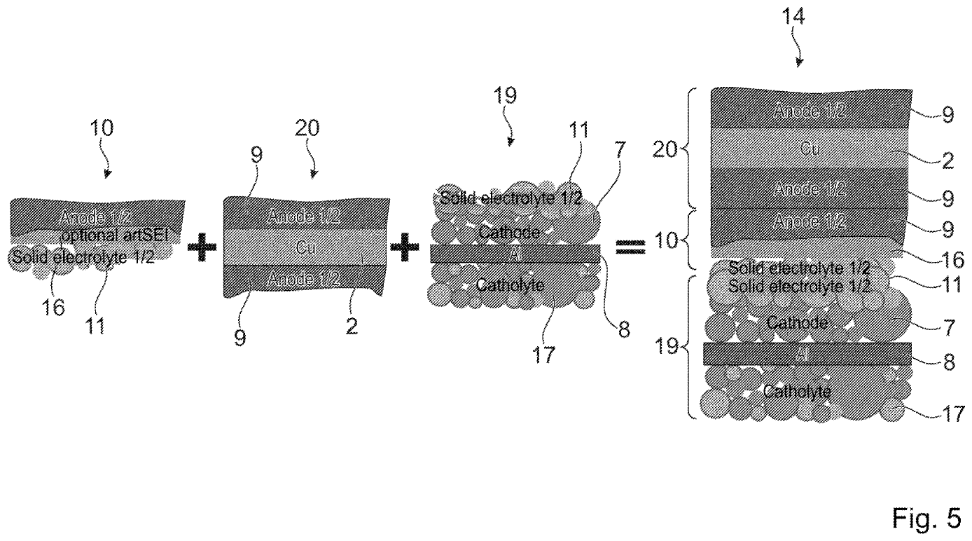

FIG. 5 Schematic representation of a further production variant for a solid-state battery cell according to the method of the invention for producing an Si anode-solid electrolyte connection;

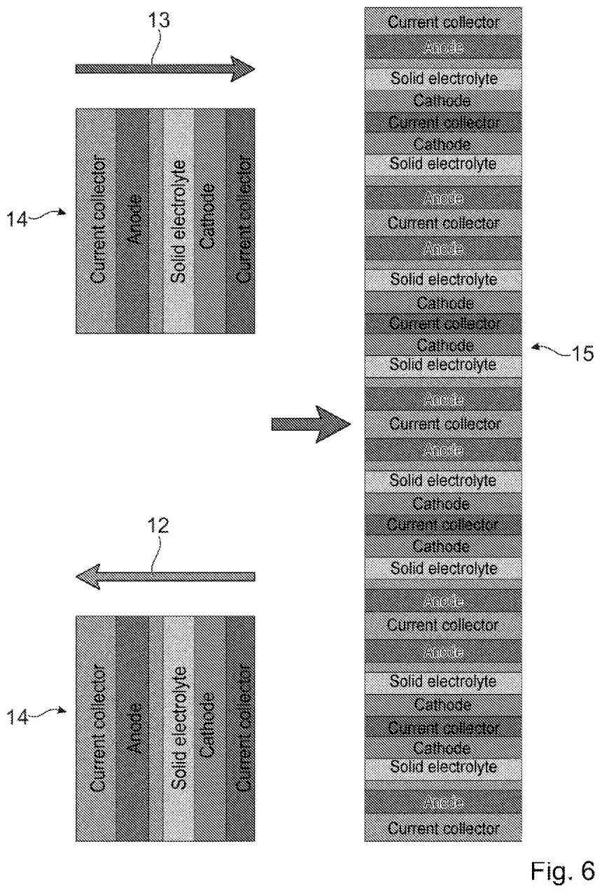

FIG. 6 Construction of a solid-state battery from a plurality of parallel-connected solid-state battery cells produced in one method.

The production of solid electrolyte 11 typically requires a high energy input in order to produce a crystalline structure with high ion conductivity. The method of the invention is suitable for this, for realizing a stable anode construction, to apply either an anode structure 9 to the solid-state electrolyte 11 (FIG. 2a) or a solid electrolyte 11 to a current collector 2 with an active layer 9, together forming an anode 9 (FIG. 2b). The accelerated annealing, especially the flash-lamp annealing, may be utilized subsequently to crystallize the stratum of the solid electrolyte through a targeted energy input, without critically damaging the anode (in accordance with FIG. 2b).

The method of the invention advantageously enables the processing of the silicon anode-solid electrolyte connection 10 to be performed in two directions. Either a multistratum structure 9 as active layer of the anode is deposited in a dry method on a solid electrolyte 11, and then the current collector 2 (FIG. 2a), or first the multistratum structure 9 for the active layer of the anode is deposited on a current collector 2, and then the solid electrolyte 11 (FIG. 2b), i.e., in reverse order. The strata or layers are stabilized by the accelerated annealing. This allows the solid-state electrolyte to be produced separately from anode production.

In the first variant (FIG. 2a), in the production process, the Si anode, composed of at least one stratum of a metal and/or silicon or of a mixed system consisting of silicon admixed with at least one metal, is deposited, in particulate form with additional layers. Direct application of the anode 9 to the solid electrolyte 11 enables optimal ionic contact to the solid electrolyte 11, which is normally difficult to contact. The process parameters necessary for this purpose and also annealing processes by means of flash-lamp annealing ought to have no substantial influence on the existing solid electrolyte 11. Lastly, a current collector 2 can be applied in suitable layer thickness to the “solid electrolyte and Si anode” structure.

As a result of the production method of the invention (see FIG. 3), the current collector 2 on the anode side in the process can be optimized in terms of electrical conductivity, layer thickness (e.g., 3 μm) and weight, as it is not required to fulfill any load-bearing function. The attachment of a current tap requires surface contact, which may be realized, for example, by the rolled application of a suitable thick diverter tab to the anode 9 directly or to the anode 9 prepared with surface deposition of metal to reduce resistance. The subsequent further deposition of an Si anode 9 is additionally realizable independently of the substrate 2. With suitable methods for the further deposition of the solid electrolyte 11, the cathode 7, the current collector 8 of the cathode, and further battery cell constructions, it is possible to construct any desired stack of a battery (FIG. 6) composed of multiple cells 14. Hence the capacity of a solid-state battery 15 can also be simply realized and/or adjusted. This stacking of anode 9/solid electrolyte 11/cathode 7 permits a highly integrated approach for the building of all-solid-state batteries.

The interlayer 16 between anode 9 and solid electrolyte 11 (see FIG. 4) serves for interface engineering and permits the targeted application of the anode 9 to the solid electrolyte 11 without extra cost and complexity.

FIG. 5 shows a production variant for a solid-state battery cell 14 according to the method of the invention for producing an Si anode-solid electrolyte connection 10. With this exemplary embodiment, both the Si anode-solid electrolyte connection 10 and the Si anode-copper current collector connection 20 and the solid electrolyte-cathode-aluminum current collector connection and/or catholyte-aluminum current collector connection 19 are produced separately from one another. For the manufacture or formation of the solid-state battery cell, the separately produced layer compositions 10, 20, 19 are connected to one another by way of their respective bulk contacts. A bulk contact refers to the active layer 9 in the case, for example, of the Si anode-solid electrolyte connection 10 and Cu current collector-Si anode connection 20, and to the solid electrolyte 11 in the case of the connection between the Si anode-solid electrolyte 10 and the solid electrolyte-cathode-aluminum current collector 19. A catholyte 17 refers to the mixture of the cathode 7 with the solid electrolyte 11.

The invention makes it possible to realize the production order of the layers of a solid-state battery cell in different orders of production, and to produce parts of the solid-state battery cell with defined interface even separately from one another, and then simply to connect them to one another in a concluding process.

The production of the stacking of layers represented in FIG. 6 for a solid-state battery 15 may be accomplished either according to a first variant of the production method for a silicon anode-solid electrolyte connection 10, in which the active layer 9 and the current collector 2 of the anode are applied to the solid electrolyte 11, or according to a second variant of the production method for a silicon anode-solid electrolyte connection 10, in which an active layer 9 as anode and subsequently the solid electrolyte 11 are applied to a current collector 2, or according to a combination of both variants.

The application of the Si anode 9 directly to the solid electrolyte 11 enables stacking in a single process instead of, as previously, in multiple facilities or approaches. This produces new possibilities for performance boosting through the targeted influencing of the interfaces. The numbers of production facilities are reduced.

Because solid electrolytes, especially solid ceramic electrolytes, are very thick and rigid, the necessary stability for an anode or solid-state battery cell can be built up by the solid electrolyte, instead of, as previously, by the current collector of the anode. A saving of metal can be achieved accordingly. The focus for optimization may therefore be directed onto the electrical contact between the interfaces of the individual battery structures.

Given that interfaces are more critical in solid-state batteries 15 than are the bulk properties, the design and the manufacture of the interfaces occupy the foreground.

A stacking of individual solid-state battery cells 14, as is represented in FIG. 6, is necessary in order to realize sufficient overall capacity for a solid-state battery 15. Previously, this was not possible, as there was no reversible manufacture for constructing an Si anode-solid electrolyte connection 10 starting from a solid electrolyte 11. This is made possible only through the planar construction of the solid electrolyte 11 and the planar anode, the accelerated annealing, and the use of dry deposition processes.

### LIST OF REFERENCE SIGNS

1 Lithium-ion battery
2 Collector on anode side
3 SEI—Solid-Electrolyte Interphase
4 Electrolyte
5 Separator
6 Conducting interphase
7 Cathode, positive electrode
8 Collector on cathode side
9 Anode, negative electrode, active layer or multistratum structure
10 Silicon-anode-solid electrolyte connection
11 Solid electrolyte
12 Fabrication order 1
13 Fabrication order 2
14 Solid-state battery cell
15 Solid-state battery
16 Interlayer; artificial solid electrolyte interface
17 Catholyte
19 Solid electrolyte-cathode-aluminum current collector connection and/or catholyte-aluminum current collector connection
20 Si anode-copper current collector connection

1. A method for producing a planar silicon anode-solid electrolyte connection suitable for use in a solid-state battery, characterized in that a multistratum structure is deposited as active layer of the Si anode onto a porous solid electrolyte in a dry deposition method, with the multistratum structure being subjected to accelerated annealing and with a current collector composed preferably of copper being deposited on the multistratum structure.

2. The method for producing a planar silicon anode-solid electrolyte connection as claimed in claim 1, characterized in that an interlayer for stabilization between the solid electrolyte and the active layer of the Si anode is deposited between the solid electrolyte and the multistratum structure.

3. The method for producing a planar silicon anode-solid electrolyte connection as claimed in claim 1, characterized in that the multistratum structure is deposited stratum by stratum, with the multistratum structure being formed from at least one stratum of a metal and/or silicon or from a mixed system which consists of silicon admixed with at least one metal.

4. The method for producing a planar silicon anode-solid electrolyte connection as claimed in claim 1, characterized in that the metal is formed from at least one of the materials manganese, Mn, cobalt, Co, iron, Fe, magnesium, Mg, titanium, Ti, nickel, Ni, aluminum, Al, tin, Sn, gold, Au and/or silver, Ag, and/or a mixture of these materials.

5. The method for producing a planar silicon anode-solid electrolyte connection as claimed in claim 1, characterized in that the dry deposition method is a PVD process: for example, sputtering or electron-beam vaporization.

6. The method for producing a planar silicon anode-solid electrolyte connection as claimed in claim 1, characterized in that the method steps for producing the planar silicon anode-solid electrolyte connection take place in reverse sequence, specifically such that the multistratum structure is deposited as active layer on the current collector of the Si anode, preferably copper, in a dry deposition method, and is subsequently subjected to accelerated annealing with a controlled and adjustable energy input into the multistratum structure of the Si anode; an interlayer is deposited on the multistratum structure for stabilization between the solid electrolyte and the active layer of the Si anode; and the solid electrolyte is deposited, the latter being subjected to accelerated annealing for crystallization of the solid electrolyte.

7. The method for producing a planar silicon anode-solid electrolyte connection as claimed in claim 1, characterized in that energy input into the deposited strata of the multistratum structure and/or layers of the silicon anode-solid electrolyte connection is controlled by means of the accelerated annealing.

8. The method for producing a planar silicon anode-solid electrolyte connection as claimed in claim 1, characterized in that the accelerated annealing is a flash-lamp annealing and can be carried out by means of a flash lamp having a flash light duration in the range from 0.2 to 20 ms and an energy density in the range from 0.3 to 160 J/cm² and/or by preheating or cooling in the range from 4° C. to 200° C.

9. The method for producing a planar silicon anode-solid electrolyte connection as claimed in claim 1, characterized in that the accelerated annealing is a laser annealing and can be carried out by means of a laser with an annealing time in the range from 0.01 ms to 100 ms by the establishment of a rate of scanning of a local heating site and an energy density in the range from 0.1 to 100 J/cm² and/or with preheating or cooling in the range from 4° C. to 200° C.

10. A planar silicon anode-solid electrolyte connection produced by the method as claimed in claim 1, characterized in that the solid electrolyte consists preferentially of an oxidic material, more particularly of garnet-structure oxides, NASICON-type phosphate glass-ceramics or oxynitrides.

11. The planar silicon anode-solid electrolyte connection as claimed in claim 10, characterized in that the solid electrolyte has a crystallinity with high ion conductivity that can be adjusted in a targeted way by means of the accelerated annealing.

12. A solid-state battery cell comprising a cathode and a planar silicon anode-solid electrolyte connection produced using the method as claimed in claim 1, characterized in that the Si anode, the solid electrolyte and the cathode are embodied with a planar construction.

13. The solid-state battery cell as claimed in claim 12, characterized in that the cathode is formed of an active layer of LiFePO₄, LiMnO₂ or LiCoO₂ and a current collector composed preferably of aluminum is formed as cathode on the active layer.

14. The solid-state battery cell as claimed in claim 1, characterized in that an anode-side construction comprising the Si anode-solid electrolyte connection and an Si anode-copper current collector connection and also a cathode-side construction comprising a solid electrolyte-cathode-aluminum current collector connection and/or catholyte-aluminum current collector connection can be produced and constructed separately from one another, with the Si anode-solid electrolyte connection and the Si anode-copper current collector connection and also the solid electrolyte-cathode-aluminum current collector connection and/or the catholyte-aluminum current collector connection being configured in a manner connectable to one another in a final fabrication step by way of a respective bulk contact.

15. The solid-state battery consisting of more than one solid-state battery cell as claimed in claim 1, with the more than one solid-state battery cell being embodied in a manner stacked planarly atop one another and with contacting being embodied in a manner connected to one another in parallel and/or in series.
